(19) United States
(12) Patent Application Publication
(10) Pub. No.: US 2009/0100246 A1
(43) Pub. Date: Apr. 16, 2009

(54) INFORMATION RETRIEVING APPARATUS AND METHOD

(75) Inventor: Teruaki UEHARA, Tokyo (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/207,537

(22) Filed: Sep. 10, 2008

(30) Foreign Application Priority Data
Oct. 15, 2007 (JP) 2007267875

(51) Int. Cl. G06F 12/00

(52) U.S. Cl. 711/216; 711/E12.001

(57) ABSTRACT

The present invention provides an information retrieving apparatus and method each of which stores predetermined information at addresses of a Main Table RAM associated with retrieval key data by substituting data indicative of each specific position of the retrieval key data in retrieval range defining data in which a range targeted for retrieval is defined by setting the retrieval range defining data as information indicative of the data being arbitrary data, with a fixed value defined in advance and performing conversion on the retrieval key data by predetermined hash functions; allows a mask Table to store position information indicative of the specific position; when retrieval key data targeted for retrieval is inputted, reads the position information from the mask Table and reads from the Main Table RAM through a data selector, the information stored at the addresses associated therewith by substituting the data indicative of each specific position indicated by the position information of the retrieval key data with the fixed value and converting the same by the hash functions, and determines whether each read information is of the predetermined information.

### BACKGROUND OF THE INVENTION

The present invention relates to an information retrieving apparatus and an information retrieving method.

High-speed table retrieval has been performed in a router 10′ that relays packet data through such Internet as shown in FIG. 14, for example. A NAPT (Network Address Port Translation) process will be explained as an example of this table retrieval.

The NAPT process is of a process run by the router 10′ and is a process for performing conversion between a private IP (=local IP) and a global IP upon Internet connection. This process makes it possible to Internet-connect a plurality of PCs simultaneously using one global IP. Its mechanism or arrangement will be mentioned below.

NAPT lying in the router 10′ changes a source address of an IP packet of (1) from “local 1IP:20” to “its own or self IP:220”. In a packet of (3) corresponding to a reply to the packet of (1), the NAPT changes a destination or forwarding address from “self IP:220” to “local 1IP:20”.

Thus, the plural PCs are capable of using one global IP.

Since this processing needs to be conducted at high speed, and a table size exceeds 1000, there has been proposed a device that uses hash functions.

FIG. 15 shows one example of a block diagram of a table retrieving apparatus that uses general hash functions.

Here, NAPT Data is contained in a Main Table RAM 34′.

Each address of the Main Table RAM 34′ is contained in a Pointer Table RAM 24′.

The operation of the table retrieving apparatus is as follows:

Upon the input of NAPT data:

(1) Retrieval key data represented as a key for retrieval is inputted to its corresponding hash function at an address converter 22′ to obtain a hash value.

(2) The Pointer Table RAM 24′ is read with the hash value as an address of the Pointer Tale RAM 24′. If the read data is empty, then a value generated at a NexPointGen 30′ is inputted to the address. If the data is not empty, then 1 is added to the hash value and the processing of (2) is performed.

(3) NAPT Data is inputted with the value generated at the NexPointGen 30′ as an address of the Main Table RAM 34′ (thereafter, a Next Pointer is added thereto).

Upon reading of NAPT data:

(1) Retrieval key data is inputted to its corresponding hash function to obtain a hash value.

(2) The Pointer Table RAM 24′ is read with the hash value as an address of the Pointer Table RAM 24′.

(3) The Main Table RAM 34′ is read with the read value as an address of the Main Table RAM 34′.

(4) If the read value is of data corresponding to the retrieval key data, such processing is terminated.

If not so, then 1 is added to the hash value and the processing of (2) is carried out.

Upon deletion of NAPT data:

(1) Retrieval key data is inputted to its corresponding hash function to obtain a hash value.

(2) The Pointer Table RAM 24′ is read with the hash value as an address of the Pointer Table RAM 24′.

(3) The Main Table RAM 34′ is read with the read value as an address of the Main Table RAM 34′.

(4) If the read value is of data corresponding to the retrieval key data, then data of the Pointer Table RAM 24′ with the hash value as its corresponding address, and data of the Main Table RAM 34′ with the contents of the Pointer Table RAM 24′ as its corresponding address are deleted.

If the read value does not correspond to the data corresponding to the retrieval key data, then 1 is added to the hash value and the processing of (2) is performed.

Since the retrieval key data and the data corresponding to the retrieval key data correspond to each other in a one-to-one relationship in the NAPT process, this process can be realized without problems by the Table retrieving method using Hash.

As a technique related to the present invention, a name index retrieving device capable of retrieving and outputting a name index or tag approximate to a key word inputted using a wildcard has been disclosed in a patent document 1 (Japanese Unexamined Patent Publication No. Hei 9(1997)-223154).

Meanwhile, there is a case in which range retrieval as to whether the inputted retrieval key data belongs to a specific range is necessary. For example, there is a case where when an inputted IP address is one lying within a specific range as in an IP filter process, the router 10′ does not relay data.

However, in the case of the retrieval that needs the range retrieval as to whether the inputted retrieval key data belongs to the specific range as in the IP filter process, the Table retrieving method using the hash could not be used.

In other words, a problem arises in that since the hash retrieval is basically of 1:1 retrieval although it enables high-speed retrieval, the hash retrieval cannot be applied to retrieval using a wildcard (special character having a given range).

Incidentally, the technique of the patent document 1 is of a technique for performing retrieval using the wildcard (┌*┘, for example) from within the table, and the technically-used situations differ in the present technique. In the technique of the patent document 1, both ab1xy and ab22xy assume ab333xy as the result of retrieval where, for example, retrieval of ab*xy is carried out, so that even unwanted data are retrieved and processing is cumbersome.

### SUMMARY OF THE INVENTION

The present invention has been made in view of the foregoing facts. It is an object of the present invention to provide an information retrieving apparatus and an information retrieving method both capable of determining whether inputted retrieval key data is of data lying within a specific range, using a hash function.

According to a first aspect of the present invention, for attaining the above object, there is provided an information retrieving apparatus comprising first storing means for storing predetermined information at addresses, the addresses being associated with retrieval key data by substituting data indicative of each specific position of the retrieval key data in retrieval range defining data in which a range targeted for retrieval is defined by setting the retrieval range defining data as information indicative of the data being arbitrary data, with a fixed value defined in advance, and performing conversion on the retrieval key data by predetermined hash functions; second storing means for storing position information indicative of the specific position therein; means for, when retrieval key data targeted for retrieval is inputted, reading the position information from the second storing means and reading from the first storing means, the information stored at the addresses associated therewith by substituting the data indicative of each specific position indicated by the position information of the retrieval key data with the fixed value and converting the retrieval key data by the hash functions; and means for determining whether each information read by the reading means is of the predetermined information.

In the invention described in the first aspect, predetermined information are stored at addresses associated with retrieval key data by substituting data indicative of each specific position of the retrieval key data in retrieval range defining data in which a range targeted for retrieval is defined by setting the retrieval range defining data as information indicative of the data being arbitrary data, with a fixed value defined in advance and performing conversion on the retrieval key data by predetermined hash functions, and position information indicative of each specific position is stored in second storing means.

In the present invention, when retrieval key data targeted for retrieval is inputted, the reading means reads position information from the second storing means and reads from the first storing means, information stored at addresses associated therewith by substituting data indicative of each specific position indicated by the position information of the retrieval key data with a fixed value and converting the same by hash functions. Further, the determining means determines whether each information read by the reading means is of predetermined information.

Thus, according to the invention described in the first aspect, predetermined information are stored at addresses of the first storing means associated with retrieval key data by substituting data indicative of each specific position in the retrieval range defining data with a fixed value defined in advance and performing conversion on the retrieval key data by predetermined hash functions. When retrieval key data targeted for retrieval is inputted, the information stored at the addresses of the first storing means associated therewith by substituting the data indicative of each specific position indicated by the position information of the retrieval key data with a fixed value and converting the same by the hash functions are read, and a decision as to whether each of the read information is of predetermined information is made, thereby making it possible to determine whether the inputted retrieval key data is of data lying within a specific range, using the hash functions.

As in the invention described in a second aspect, the present invention may be provided in such a manner that the first storing means stores information associated with retrieval key data at addresses associated with the data by converting the retrieval key data using the hash functions, and when retrieval key data targeted for retrieval is inputted, the reading means further reads from the first storing means, the information stored at the addresses associated with the data by converting the retrieval key data using the hash functions.

According to the present invention as in the invention described in a third aspect, when a plurality of retrieval range data identical in the specific position are registered, only one position information is preferably stored as the position information.

In the invention described in the first through third aspects, the position information may be of information indicating the specific position by a bit position as in the invention described in a fourth aspect.

Further, in the invention described in the first through third aspects, the position information may be of information indicating the specific position by the number of bits as counted from the least significant bit as in the invention described in a fifth aspect.

On the other hand, according to a sixth aspect of the invention, for attaining the above object, there is provided an information retrieving method comprising the steps of storing predetermined information at addresses of first storing means associated with retrieval key data by substituting data indicative of each specific position of the retrieval key data in retrieval range defining data in which a range targeted for retrieval is defined by setting the retrieval range defining data as information indicative of the data being arbitrary data, with a fixed value defined in advance and performing conversion on the retrieval key data by predetermined hash functions, and storing position information indicative of the specific position in second storing means; when retrieval key data targeted for retrieval is inputted, reading the position information from the second storing means and reading from the first storing means, the information stored at the addresses associated therewith by substituting the data indicative of each specific position indicated by the position information of the retrieval key data with the fixed value and converting the same by the hash functions; and determining whether each read information is of the predetermined information.

Thus, since the invention described in the sixth aspect acts in a manner similar to the invention described in the first aspect, it can be determined whether inputted retrieval key data is of data lying within a specific range, using each hash function.

According to the present invention as described above, it has an excellent effect in that it is possible to determine using each hash function whether inputted retrieval key data corresponds to data lying within a specific range.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram showing a schematic configuration of a router according to an embodiment;

FIG. 2 is a flowchart illustrating the flow of a retrieval key registering process according to the embodiment;

FIG. 3 is a flowchart depicting the flow of a retrieval range registering process according to a first preferred embodiment;

FIG. 4 is a diagram showing one example of a data structure of data stored in a mask Table according to the first preferred embodiment;

FIG. 5 is a flowchart illustrating the flow of a retrieving process according to the first preferred embodiment;

FIG. 6 is a flowchart depicting the flow of a retrieval key deleting process according to the embodiment;

FIG. 7 is a flowchart showing the flow of a retrieval range deleting process according to the first preferred embodiment;

FIG. 8 is a diagram showing one example of a data structure of data stored in the mask Table according to the first preferred embodiment;

FIG. 9 is a flowchart showing the flow of a retrieval range registering process according to a second preferred embodiment;

FIG. 10 is a diagram illustrating one example of a data structure of data stored in a mask Table according to the second preferred embodiment;

FIG. 11 is a flowchart depicting the flow of a retrieving process according to the second preferred embodiment;

FIG. 12 is a flowchart showing the flow of a retrieval range deleting process according to the second preferred embodiment;

FIG. 13 is a diagram illustrating one example of a data structure of data stored in the mask Table according to the second preferred embodiment;

FIG. 14 is a typical diagram showing a router that relays conventional packet data; and

FIG. 15 is a block diagram depicting a schematic configuration of a router according to an embodiment.

### DETAILED DESCRIPTION OF THE PREFERRED EMBODIMENTS

Preferred embodiments of the present invention will hereinafter be described in detail with reference to the accompanying drawings. Incidentally, a description will be made of a case in which the present invention is applied to a NAPT process that runs on a router.

### First Preferred Embodiment

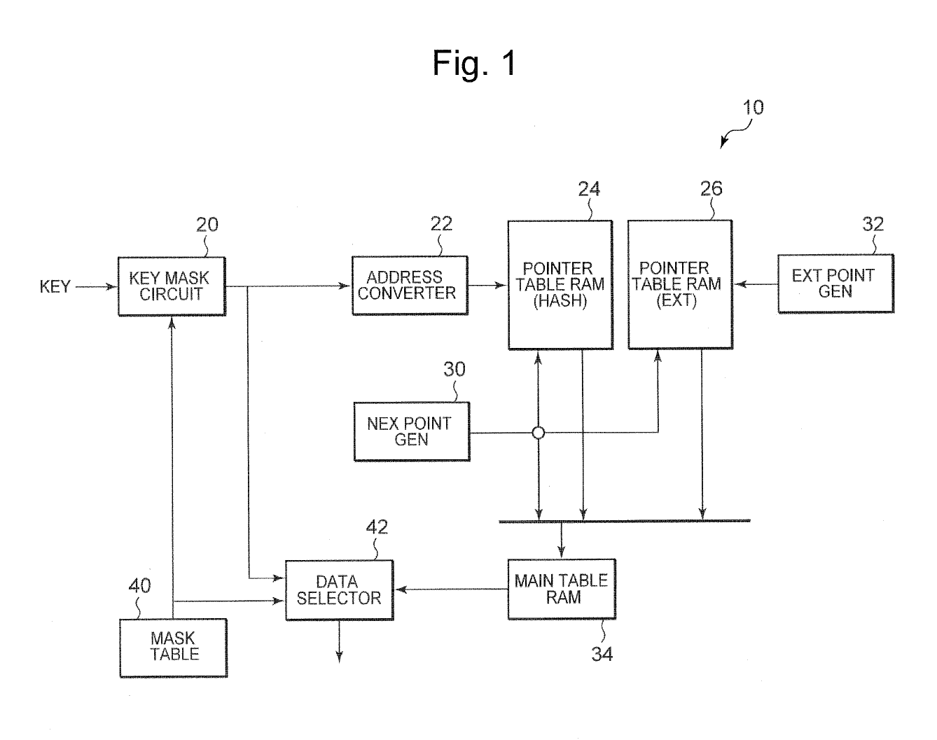

FIG. 1 shows a schematic configuration of a portion related to an NAPT process that runs on a router according to a first preferred embodiment.

The router 10 according to the present embodiment comprises a KEY mask circuit 20, an address converter 22, a Pointer Table PAM (Hash) 24, a Pointer Table TAM (EXT) 26, a NexPointGen 30, an ExtPointGen 32, a Main Table PAM 34, a mask Table 40 and a data selector 42.

Retrieval key data and retrieval range specifying or defining data for defining or specifying a range targeted for retrieval are inputted to the KEY mask circuit 20 along with instruction information for instructing registration, retrieval and deletion of respective data. Incidentally, the range targeted for retrieval is specified or defined by setting the retrieval range defining data according to the present embodiment as a wildcard (┌*┘ in the present embodiment) indicative of a specific position of retrieval key data being arbitrary data.

The KEY mask circuit 20 performs various processes such as a mask process on the inputted retrieval key data and retrieval range defining data according to the inputted instruction information and outputs the processed retrieval key data and retrieval range defining data to the address converter 22 together with the instruction information.

The address converter 22 perform conversion on the inputted retrieval key data and retrieval range defining data by predetermined hash functions to thereby to derive addresses of the mask Table 40 associated with the retrieval key data and retrieval range defining data.

Addresses of storage regions in the data-registered main Table RAM 34 are stored in the Pointer Table RAM (Hash) 24 and the Pointer Table RAM (EXT) 26 in association with hash values.

The NexPointGen 30 generates addresses of storage regions in the data non-registered Main Table RAM 34 in address order.

The ExtPointGen 32 generates addresses of storage regions in the data non-registered Pointer Table TAM (EXT) 26 in address order.

Information associated with the retrieval key data and retrieval range defining data are stored in the Main Table PAM 34 at their corresponding addresses associated therewith by converting the retrieval key data and retrieval range defining data by the hash functions. In the present embodiment, NAPT Data such as address information such as an IP address or the like to be converted, control information, etc. are stored as the associated information.

Position information indicative of the position of the wildcard for the registered retrieval range defining data is stored in the mask Table 40.

The data selector 42 determines whether the data retrieved from the Main Table RAM 34 is of data corresponding to the retrieval key data.

The basic operation of the router 10 according to the present embodiment will next be explained.

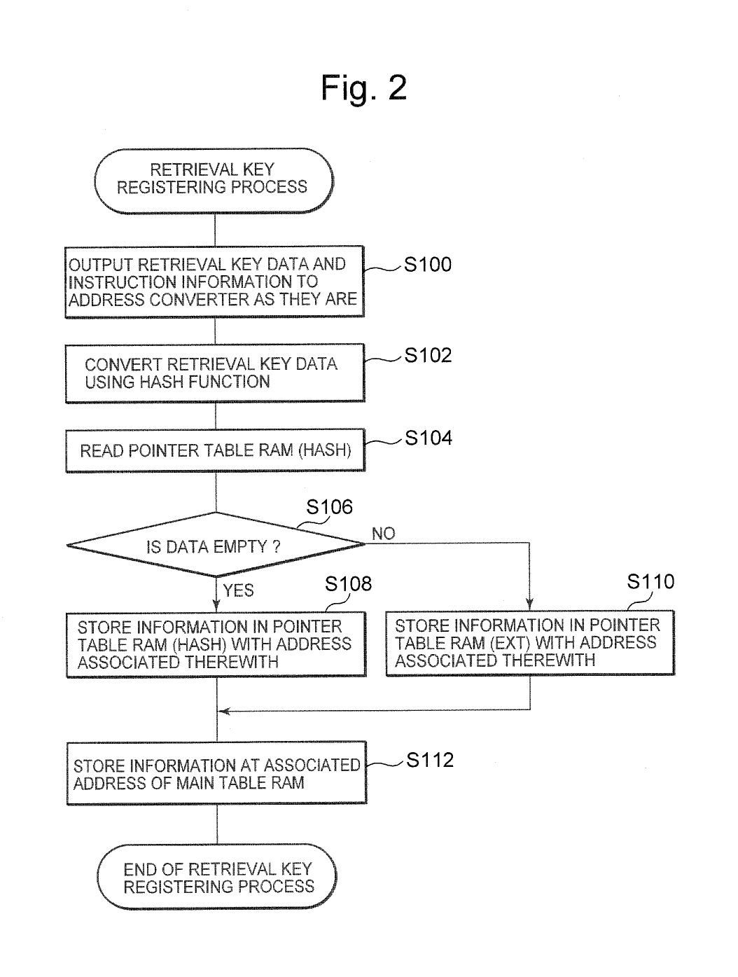

The flow of a retrieval key registering process for registering retrieval key data will first be described with reference to FIG. 2.

When the registration of the retrieval key data is performed, retrieval key data (IP address, for example) that assumes a key for retrieval, and instruction information for instructing the registration thereof are inputted to the KEY mask circuit 20.

When the retrieval key data and the instruction information for instructing its registration are inputted to the KEY mask circuit 20, the KEY mask circuit 20 outputs the retrieval key data and the instruction information to the address converter 22 as they are (Step S100).

The address converter 22 converts the retrieval key data using the hash function to obtain a hash value (Step S102).

The address converter 22 reads the Pointer Table RAM (Hash) 24 with the hash value obtained at Step S102 as an address of each storage region (Step S104).

The address converter 22 determines whether data at the read address is empty (Step S106). If the data at the read address is empty, then the value generated at the NexPointGen 30 is stored at the read address (Step 108). On the other hand, if the data at the read address is not empty, then each value generated at the NexPointGen 30 is inputted to the Pointer Table RAM (EXT) 26 with a value generated at the ExtPointGen 32 as an address of each storage region of the Pointer Table RAM (EXT) 26 (Step S110). The ExtPointGen 32 sets each generated value as an address of the next data non-registered region in address order of each storage region (for example, 1 is added to the generated value (Pointer)).

The data selector 42 allows the Main Table RAM 34 to store NAPT data and retrieval key data with each value generated at the NexPointGen 30 as an address of the Main Table RAM 34 (Step S112). The NexPointGen 30 sets each generated value as an address of the next data non-registered region in address order in each storage region (for example, 1 is added to the generated value (Pointer)).

Thus, the NAPT data such as the IP address to be converted, and the retrieval key data are stored in the Main Table RAM 34 at the addresses associated therewith by converging the retrieval key data using the hash functions.

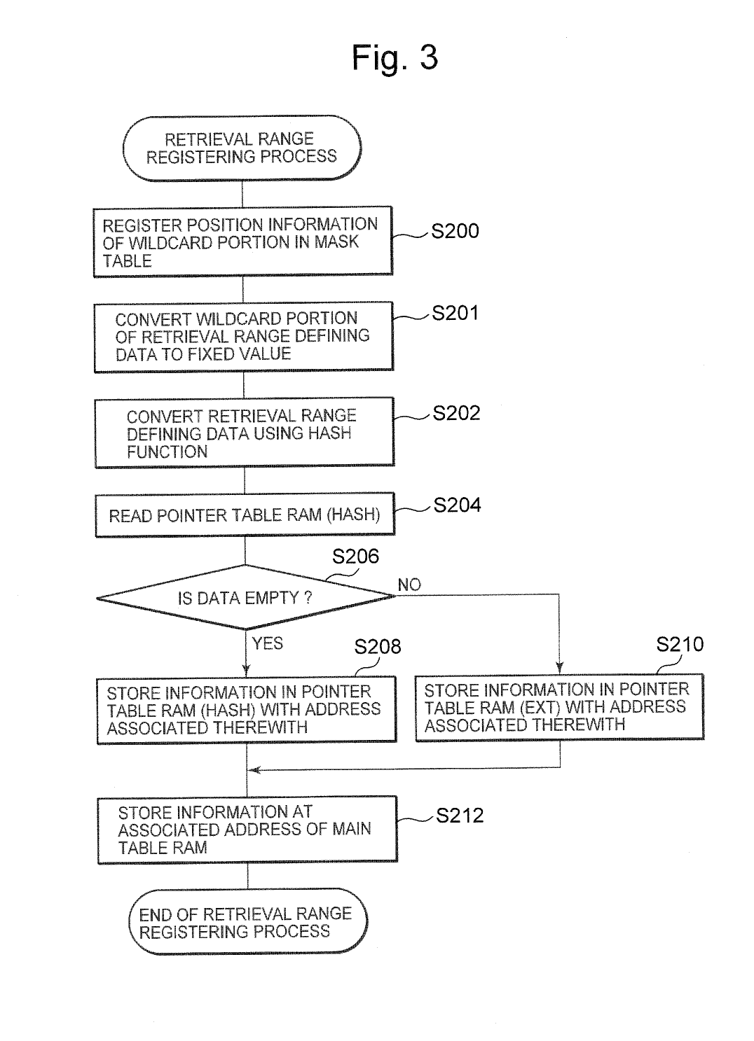

The flow of a retrieval range registering process for registering retrieval range defining data will next be explained with reference to FIG. 3.

When the retrieval range defining data is registered, the retrieval range defining data and instruction information for instructing its registration are inputted to the KEY mask circuit 20.

The KEY mask circuit 20 specifies the position of a wildcard portion for the retrieval range defining data and registers position information indicative of the position of the specified wildcard portion in the mask Table 40 (Step S200).

The KEY mask circuit 20 converts data about the wildcard portion for the retrieval range defining data to a fixed value (“0”, for example) determined in advance and outputs the converted retrieval range defining data and instruction information to the address converter 22 (Step S201).

The address converter 22 converts the retrieval range defining data using a hash function to obtain a hash value (Step S202).

The address converter 22 reads the Pointer Table RAM (Hash) 24 with the hash value obtained at Step S202 as an address of each storage region (Step S204).

The address converter 22 determines whether data at the read address is empty (Step S206). If the data at the read address is empty, then each value generated at the NexPointGen 30 is placed into the read address (Step S208). On the other hand, if the data at the read address is not empty, then each value generated at the NexPointGen 30 is inputted to the Pointer Table RAM (EXT) 26 with a value generated at the ExtPointGen 32 as an address of each storage region of the Pointer Table RAM (EXT) 26 (Step S210). The ExtPointGen 32 sets each generated value as an address of the next data non-registered region in address order in the storage region (for example, 1 is added to the generated value (Pointer)).

The data selector 42 allows the Main Table RAM 34 to store control information and retrieval range defining data with each value generated at the NexPointGen 30 as an address of the Main Table RAM 34 (Step S212). The NexPointGen 30 sets each generated value as an address of the next data non-registered region in address order in the storage region (for example, 1 is added to the generated value (Pointer)).

Thus, the control information and the retrieval range defining data are stored in the Main Table RAM 34 at their corresponding addresses associated therewith by masking data of the wildcard portion for the retrieval range defining data with a fixed value and converting the data using hash functions.

The operation of the router will be described here citing specific examples.

Incidentally, assume that in order to provide an easy description, retrieval range defining data is 8 bits and corresponding information associated therewith is 8 bits.

(1) Data set operations

Retrieval range defining data=0b1000****, corresponding information=0×01

Retrieval range defining data=0b110011***, corresponding information=0×02

Retrieval range defining data=0b1010****, corresponding information=0×03

Note: * indicates wildcard portion.

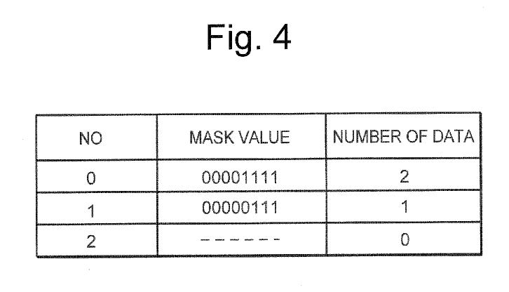

When such retrieval range defining data as described above is set, position information indicative of a bit position of each wildcard portion for such retrieval range defining data as shown in FIG. 4 is stored in the mask Table 40.

The position information according to the present embodiment indicates the bit position of each wildcard portion with the bit position of the wildcard portion for the retrieval range defining data as ‘1’ and each bit position other than each wildcard portion as ‘0’.

Number-of-data regions are provided in the mask Table 40 according to the present embodiment. When a plurality of retrieval range defining data identical in the position indicative of the wildcard portion are registered, the numbers of the registered retrieval range defining data are stored in the number-of-data regions respectively.

When the position information indicative of the position of each wildcard portion is registered in the mask Table 40, the KEY mask circuit 20 according to the present embodiment counts up the value of the number-of-data region corresponding to the position information by 1 where the corresponding position information already exists in the mask Table 40.

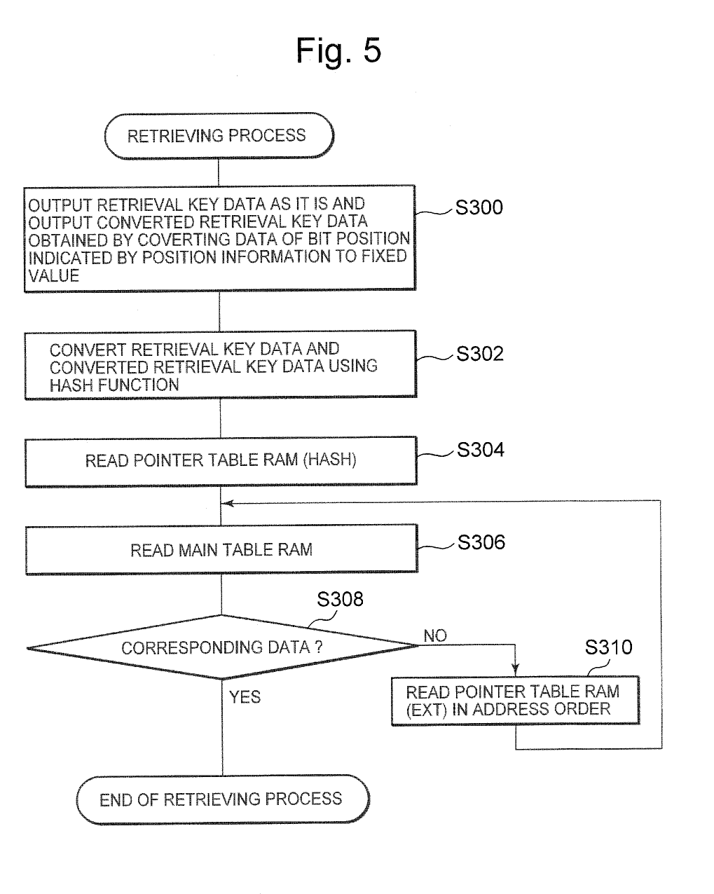

The flow of a retrieving process for performing retrieval based on retrieval key data will next be explained with reference to FIG. 5.

When the retrieval using the retrieval key data is performed, the retrieval key data and instruction information for instructing the retrieval are inputted to the KEY mask circuit 20.

The KEY mask circuit 20 outputs the retrieval key data and the instruction information to the address converter 22 as they are. Further, the KEY mask circuit 20 reads the respective position information from the mask Table 40 respectively and outputs respective retrieval key data (hereinafter called “converted retrieval key data”) obtained by converting data about bit positions indicated by the position information of the retrieval key data to a predetermined fixed value (for example “0”), based on the position information, to the address converter 22 every position information (Step S300).

The address converter 22 performs conversion of the retrieval key data and the converted retrieval key data using hash functions respectively to obtain hash values (Step S302).

The address converter 22 reads the Pointer Table RAM (Hash) 24 with the respective hash values obtained at Step S302 as their corresponding addresses of the Pointer Table RAM (Hash) 24 (Step S304).

The Main Table RAM 34 is read with the read values as the addresses of the Main Table RAM 34 (Step S306).

The data selector 42 determines whether the information read at Step S306 corresponds to NAPT Data and/or control information corresponding to the retrieval key data (Step S308). If the information is found to correspond thereto, then the data selector 42 outputs the NAPT Data and/or control information to the outside, and the retrieving process is terminated. On the other hand, if the information is found not to correspond to the NAPT Data and/or control information corresponding to the retrieval key data, then the data selector 42 reads the Pointer Table RAM (EXT) 26 in order from an address 0 (Step S310), and thereafter the process of S306 is performed.

Thus, when the retrieval key data targeted for retrieval is being registered in the Main Table RAM 34, the information stored at each address associated therewith by converting the retrieval key data using the hash function is read from the Main Table RAM 34.

When the retrieval range defining data is being registered, it is determined whether a retrieval range corresponds to a range designated by the corresponding retrieval range specifying data with the retrieval key data targeted for retrieval registered therein.

The operation of the router will be described here citing specific examples.

When the mask Table 40 is placed in, for example, such a state as shown in FIG. 4 and the retrieval key data targeted for retrieval=10001010 is retrieved, the converted retrieval key data=10000000 is generated from the retrieval key data=10001010 and the value=00001111 of NO. 0 of the mask Table 40 and converted using a hash function at the KEY mask circuit 20.

As a result, the converted retrieval key data=10000000 and Data=0×01 are read into the data selector 42.

The data are determined as being coincident with each other from the retrieval key data=10001010 as a target for retrieval and the value=00001111 of NO. 0 of the mask Table 40. When they coincide with each other, it can be specified as being data lying within a designated range. Thereafter, this is performed even on NO. 1 of the mask Table 40.

The retrieval of each data having the wildcard can be realized by these operations.

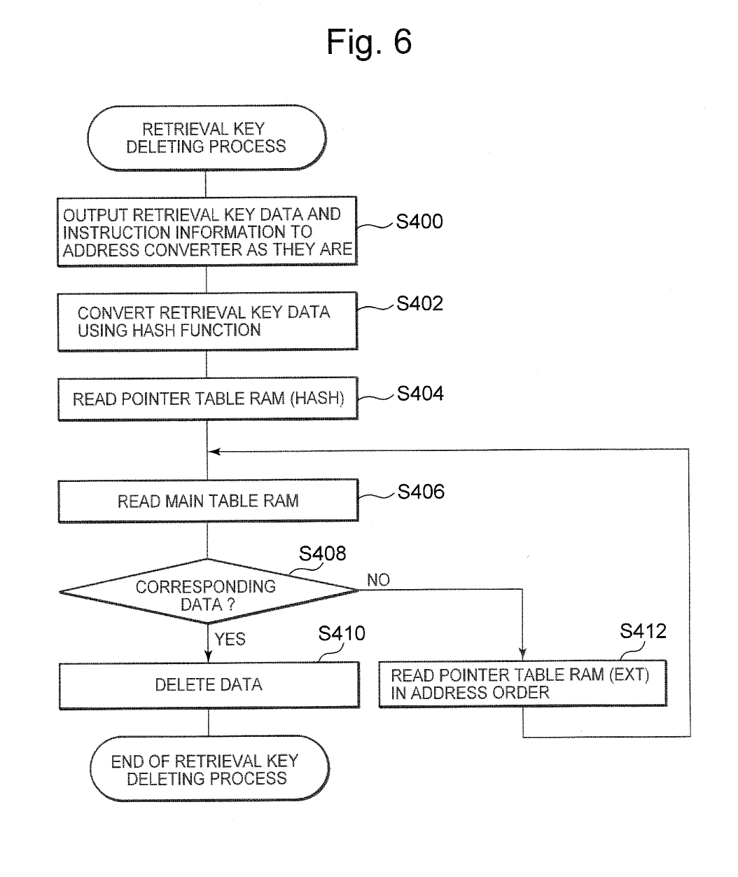

The flow of a retrieval key deleting process for performing the deletion of retrieval key data will next be explained with reference to FIG. 6.

When the retrieval key data is deleted, the retrieval key data and instruction information for instructing its deletion are inputted to the KEY mask circuit 20.

When the retrieval key data and the instruction information for instructing its deletion are inputted to the KEY mask circuit 20, the KEY mask circuit 20 outputs the retrieval key data and the instruction information to the address converter 22 as they are (Step S400).

The address converter 22 performs conversion of the retrieval key data using hash functions to obtain hash values (Step S402).

The address converter 22 reads the Pointer Table RAM (Hash) 24 with the respective hash values obtained at Step S402 as their corresponding addresses of the Pointer Table RAM (Hash) 24 (Step S404).

The Main Table RAM 34 is read with the read values as the addresses of the Main Table RAM 34 (Step S406).

The data selector 42 determines whether each information read at Step S406 corresponds to NAPT Data or control information corresponding to the retrieval key data (Step S408). If the information is found to correspond thereto, then the data selector 42 deletes the data of the Pointer Table RAM (Hash) 24 and the data of the Main Table RAM 34 (Step S410), and the retrieval key deleting process is terminated. On the other hand, if the information is found not to correspond to the NAPT Data or control information corresponding to the retrieval key data, then the data selector 42 reads the Pointer Table RAM (EXT) 26 in order from an address 0 (Step S412), and thereafter the process of S406 is performed.

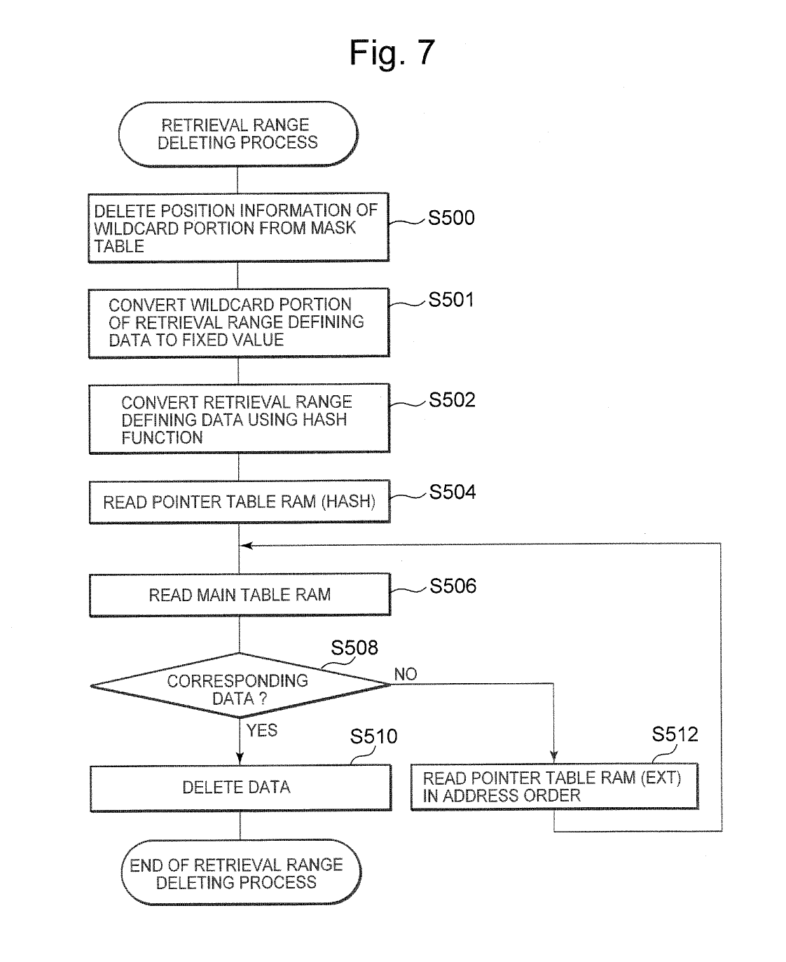

The flow of a retrieval range deleting process for deleting retrieval range defining data will next be described with reference to FIG. 7.

When the retrieval range defining data is deleted, the retrieval range defining data and instruction information for instructing its deletion are inputted to the KEY mask circuit 20.

The KEY mask circuit 20 specifies the position of each wildcard portion of the retrieval range defining data and retrieves whether position information indicative of the position of the specified wildcard portion is registered in the mask Table 40. When the position information has been registered in the mask Table 40 and the value of the number-of-data region corresponding to the position information is ‘1’ or less, the KEY mask circuit 20 deletes the record of the corresponding position information. When the value of the number-of-data region is greater than ‘1’, the KEY mask circuit 20 subtracts 1 from the value of the number-of-data region (Step S500).

The KEY mask circuit 20 converts data about each wildcard portion of the retrieval range defining data to a predetermined fixed value (“0”, for example) and outputs the converted retrieval range defining data and instruction information to the address converter 22 (Step S501).

The address converter 22 performs conversion of the retrieval range defining data using hash functions to obtain hash values (Step S502).

The address converter 22 reads the Pointer Table RAM (Hash) 24 with each hash value obtained at Step S502 as an address of each storage region (Step S504).

Then, the Mail Table RAM 34 is read with each read value as an address of the Main Table RAM 34 (Step S506).

The data selector 42 determines whether the information read at Step S506 corresponds to NAPT Data or control information corresponding to the retrieval range defining data (Step S508). If they correspond to each other, then the data selector 42 deletes data of the Pointer Table RAM (Hash) 24 and data of the Main Table RAM 34 (Step S510), and the retrieval range deleting process is terminated. On the other hand, if the information is found not to correspond to the NAPT Data or control information corresponding to the retrieval range defining data, then the Pointer Table RAM (EXT) 26 is read in order from an address 0 (Step S512), and the process of S506 referred to above is performed.

The operation of the router will be explained here by citing a specific example.

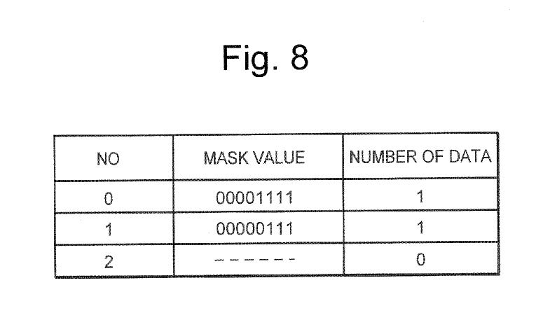

When, for example, data indicative of retrieval range defining data=0b1000**** is deleted from the mask Table 40 shown in FIG. 4, the number of data each having the same pattern is decremented by 1 at the mask Table 40. The mask Table 40 subsequent to the execution of this processing is represented as shown in FIG. 8.

According to the present embodiment as described above, predetermined information are stored at addresses of the Main Table RAM 34 associated with their corresponding data by substituting data indicative of each specific position of retrieval range defining data with a fixed value determined in advance and converting the same by predetermined hash functions. When retrieval key data targeted for retrieval is inputted, the information stored at each of the addresses of the Main Table RAM 34 associated therewith by substituting data indicative of each specific position indicated by position information about the retrieval key data with a fixed value and converting the same by the hash functions is read. Determining whether the read information is of predetermined information makes it possible to determine whether the inputted retrieval key data corresponds to data lying within a specific range, using the hash functions.

According to the present embodiment as well, the range retrieval of the retrieval key data and the retrieval of corresponding data can be performed in parallel.

Further, according to the present embodiment, when wildcard portions of retrieval range defining data are identical, only one position information indicative of the position of the wildcard portion is stored. Therefore, storage regions to be used can be reduced. Since converted retrieval key data are generated one by one corresponding to the respective position information, the retrieval speed for range retrieval is improved by storing only one position information where the wildcard portions are identical to each other.

Furthermore, according to the present embodiment, since position information is of information indicating each specific position by a bit position, a plurality of positions placed in non-continuation with, for example, 100**0*0 or the like can be designated as wildcards.

### Second Preferred Embodiment

A router 10 according to a second preferred embodiment is configured as one in which as retrieval range defining data, retrieval key data and the number of bits as counted from the least significant bit of each wildcard portion are inputted.

Since the router 10 according to the second preferred embodiment is identical in configuration to that according to the first preferred embodiment (refer to FIG. 1), the description thereof will be omitted here.

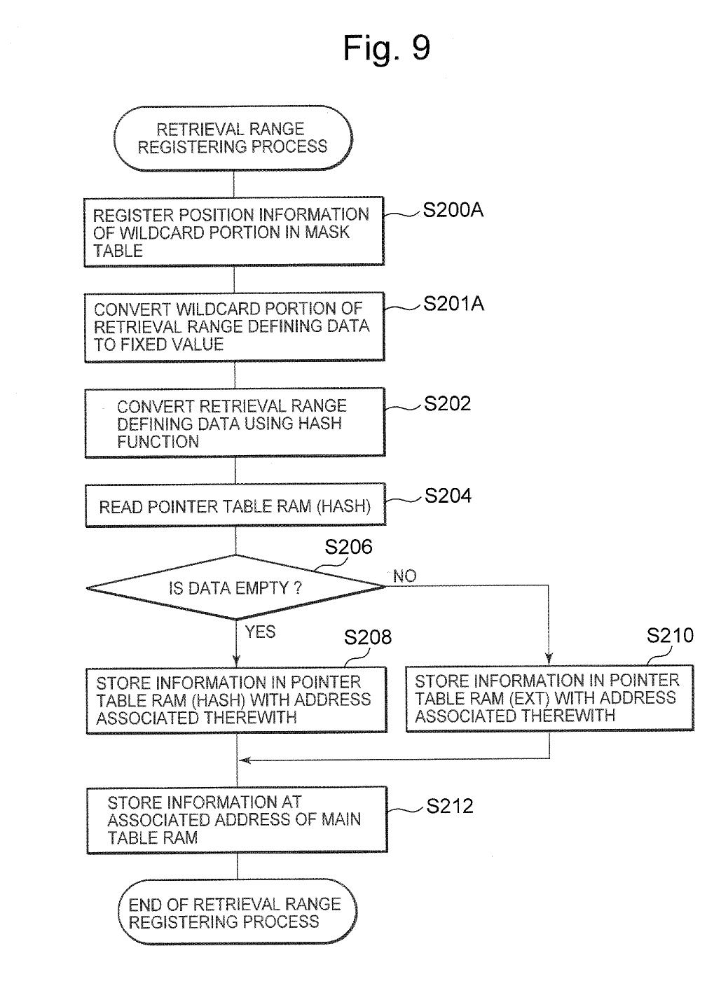

The flow of a retrieval range registering process for registering retrieval range defining data will next be explained with reference to FIG. 9. Incidentally, the same reference numerals are respectively attached to the same processes as FIG. 3 in the same figure, and their explanations will be omitted here.

When the retrieval range defining data is registered, information indicating the numbers of bits as counted from the least significant bits of retrieval key data and each wildcard portion, and instruction information for instructing registration thereof are inputted to a KEY mask circuit 20 as retrieval range defining data.

The KEY mask circuit 20 registers the number of bits as counted from the least significant bit of the wildcard portion in a mask Table 40 as position information (Step S200A).

The KEY mask circuit 20 converts data of each wildcard portion in the retrieval range defining data to a fixed value (“0”, for example) defined in advance, based on the number of bits as counted from the least significant bit and outputs the converted retrieval key data to an address converter 22 (Step S201A).

The operation of the router will be explained here citing specific examples.

(1) Data Set Operations

Retrieval key data=0b10001111, the number of bits of wildcard portion=4, corresponding information=0×01 Retrieval key data=0b11011000, the number of bits of wildcard portion=3, corresponding information=0×02 Retrieval key data=0b10100000, the number of bits of wildcard portion=4, corresponding information=0×03.

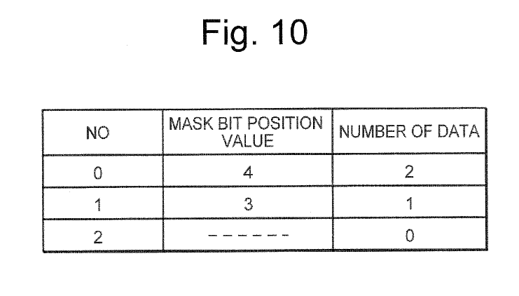

When such retrieval range defining data as described above is set, the number of bits as counted from the least significant bit of each wildcard portion such as shown in FIG. 10 is stored in the mask Table 40 as position information.

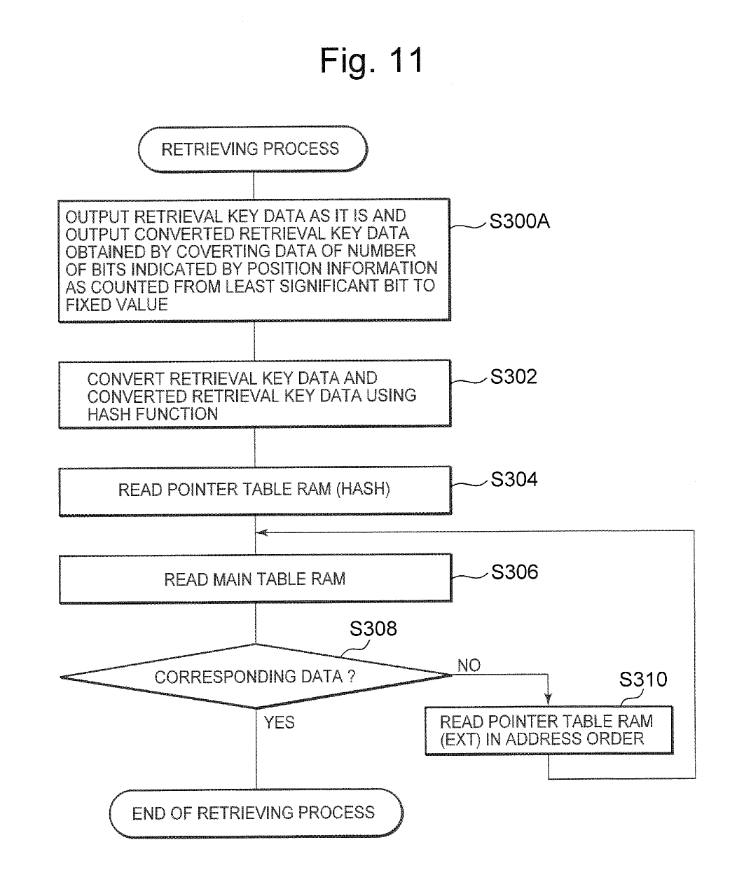

The flow of a retrieving process taken when retrieval based on retrieval key data is conducted, will next be explained with reference to FIG. 11. Incidentally, the same reference numerals are respectively attached to the same processes as FIG. 5 in the same figure, and their explanation will be omitted here.

When the retrieval based on the retrieval key data is performed, the KEY mask circuit 20 is inputted with the retrieval key data and instruction information for instructing the retrieval.

The KWY mask circuit 20 outputs the retrieval key data and the instruction information to the address converter 22 as they are. Further, the KEY mask circuit 20 reads the respective position Information from the mask Table 40 respectively and generates converted retrieval key data obtained by converting data about the number of bits indicated by the position information as counted from the least significant bit of the retrieval key data to a predetermined fixed value (for example “0”), based on the position information every position information, and outputs the respective converted retrieval key data to the address converter 22 (Step S300A).

The operation of the router will be explained here citing specific example.

When the mask Table 40 is placed in, for example, such a state as shown in FIG. 10 and the retrieval key data=10001010 is retrieved, the KEY mask circuit 20 generates a mask value=00001111 from the value=4 of NO. 0 of the mask Table 40.

The KEY mask circuit 20 generates converted retrieval key data=10000000 from the key=10001010 and the mask value=00001111 and performs retrieval.

As a result, the converted retrieval key data=10000000 and Data=0×01 are read into the corresponding data selector 42.

The data are determined as being coincident with each other from the key=10001010 and the mask value=00001111. Thereafter, this is performed even on NO. 1 of the Table.

The retrieval of each data having the wildcard can be realized by these operations.

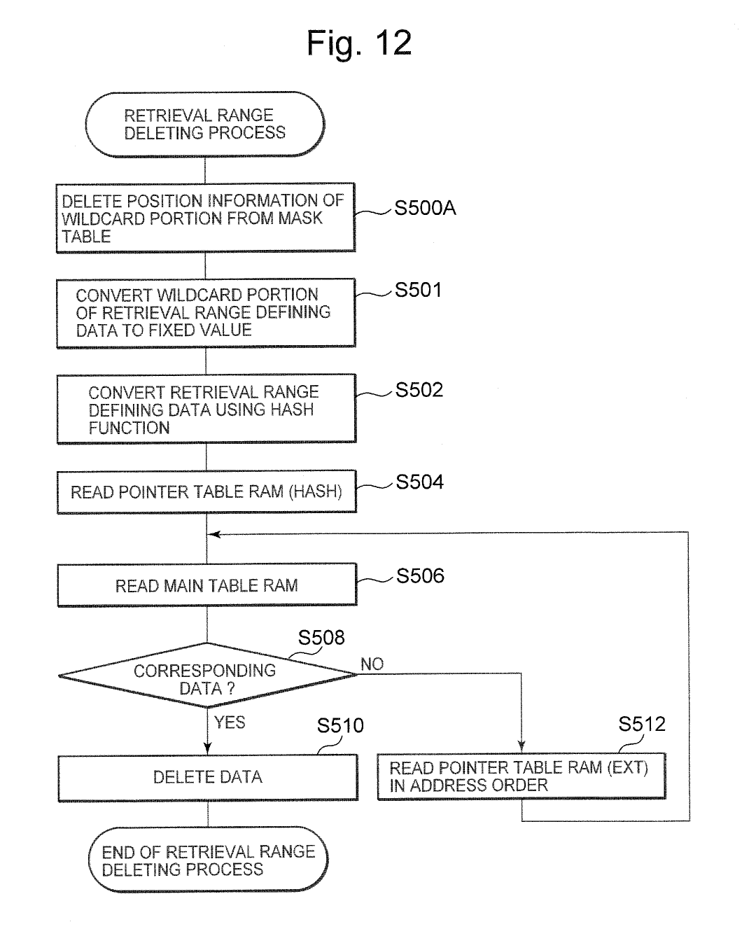

The flow of a retrieval key deleting process for performing the deletion of retrieval range defining data will next be explained with reference to FIG. 12. Incidentally, the same reference numerals are respectively attached to the same processes as FIG. 7 in the same figure, and their explanations will be omitted here.

When the retrieval range defining data is deleted, the KEY mask circuit 20 is inputted with information indicative of the numbers of bits as counted from the least significant bits of retrieval key data and each wildcard portion as the retrieval range defining data, and instruction information for instructing the deletion thereof.

The KEY mask circuit 20 performs retrieval as to whether the number of bits as counted from the least significant bit of each wildcard portion, of the numbers of bits as counted from the least significant bits of the inputted retrieval key data and the wildcard portions, has been registered in the mask Table 40 as position information. When each position information is registered in the mask Table 40 and the value of a number-of-data region corresponding to the position information is ‘1’ or less, the KEY mask circuit 20 deletes the record of the corresponding position information. When the value of the number-of-data region is greater than ‘1’, the KEY mask circuit 20 subtracts 1 from the value of the number-of-data region (Step S500A).

The KEY mask circuit 20 converts data about the wildcard portion of the retrieval key data to a predetermined fixed value (“0”, for example), based on the number of bits as counted from the least significant bit and outputs the converted retrieval key data to the address converter 22 (Step S501A).

The operation of the router will be explained here citing a specific example.

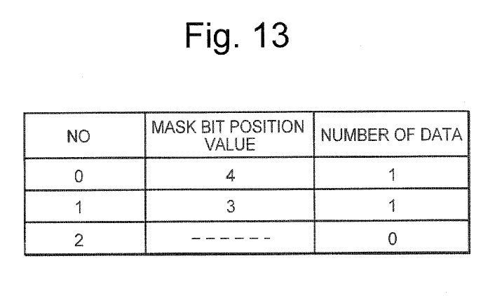

When the retrieval key data=0b10001111 and the data about the number of bits=4 inputted as the retrieval range defining data from the mask Table 40 shown in FIG. 10, for example, are deleted, the number of data each having the same bit position is reduced by 1 at the mask Table. After execution of this processing, the mask Table is represented as shown in FIG. 13.

According to the present embodiment as described above, since each position information is of the information in which each specific position is represented by the number of bits as counted from the least significant bit, the quantity of data for the information indicative of the specific position can be reduced low.

Incidentally, although the present embodiment has explained the case where the addresses are stored corresponding to the hash values using the two of the Pointer Table RAM (Hash) 24 and the Pointer Table PAM (EXT) 26, the present invention is not limited to or by it. As described in the background art, for example, the present invention may be applied to an information retrieving apparatus of such a form that where hash values overlap each other using one Pointer Table PAM, 1 is added to the corresponding hash value.

Although the present embodiment has explained where the present invention is applied to the router 10, the present invention is not limited to it.

In addition to the above, the configuration of the router 10 described in the present embodiment is one example. It is needless to say that changes can suitably be made thereto within the scope not departing from the gist of the present invention.

The flow of each of the processes (FIG. 2, FIG. 3, FIGS. 5 through 7, FIG. 9, FIG. 11 and FIG. 12) described in the present embodiments is one example. It is needless to say that changes can suitably be made thereto within the scope not departing from the gist of the present invention.

### DRAWINGS

FIG. 1

20 . . . key MASK CIRCUIT, 22 . . . ADDRESS CONVERTER, 40 . . . MASK Table, 42 . . . DATA SELECTOR

FIG. 2

Retrieval Key Registering Process
S100 . . . OUTPUT RETRIEVAL KEY DATA AND INSTRUCTION INFORMATION TO ADDRESS CONVERTER AS THEY ARE
S102 . . . CONVERT RETRIEVAL KEY DATA USING HASH FUNCTION
S104 . . . READ Pointer Table RAM (Hash)
S106 . . . IS DATA EMPTY?
S108 . . . STORE INFORMATION IN Pointer Table RAM (Hash) WITH ADDRESS ASSOCIATED THEREWITH
S110 . . . STORE INFORMATION IN Pointer Table RAM (Ext) WITH ADDRESS ASSOCIATED THEREWITH
S112 . . . STORE INFORMATION AT ASSOCIATED ADDRESS OF Main Table RAM

End of Retrieval Key Registering Process

### FIG. 3

Retrieval Range Registering Process
S200 . . . REGISTER POSITION INFORMATION OF WILDCARD PORTION IN MASK Table
S201 . . . CONVERT WILDCARD PORTION OF RETRIEVAL RANGE DEFINING DATA TO FIXED VALUE
S202 . . . CONVERT RETRIEVAL RANGE DEFINING DATA USING HASH FUNCTION
S204 . . . READ Pointer Table RAM (Hash)
S206 . . . IS DATA EMPTY?
S208 . . . STORE INFORMATION IN Pointer Table RAM (Hash) WITH ADDRESS ASSOCIATED THEREWITH
S210 . . . STORE INFORMATION IN Pointer Table RAM (Ext) WITH ADDRESS ASSOCIATED THEREWITH
S212 . . . STORE INFORMATION AT ASSOCIATED ADDRESS OF Main Table RAM

End of Retrieval Range Registering Process

### FIG. 4

### Mask Value Number of Data

### FIG. 5

Retrieving Process
S300 . . . OUTPUT RETRIEVAL KEY DATA AS IT IS AND OUTPUT CONVERTED RETRIEVAL KEY DATA OBTAINED BY COVERTING DATA OF BIT POSITION INDICATED BY POSITION INFORMATION TO FIXED VALUE
S302 . . . CONVERT RETRIEVAL KEY DATA AND CONVERTED RETRIEVAL KEY DATA USING HASH FUNCTION
S304 . . . READ Pointer Table RAM (Hash)
S306 . . . READ Main Table RAM
S308 . . . CORRESPONDING DATA?
S310 . . . READ Pointer Table RAM (Ext) IN ADDRESS ORDER

End of Retrieving Process

### FIG. 6

Retrieval Key Deleting Process
S400 . . . OUTPUT RETRIEVAL KEY DATA AND INSTRUCTION INFORMATION TO ADDRESS CONVERTER AS THEY ARE
S402 . . . CONVERT RETRIEVAL KEY DATA USING HASH FUNCTION
S404 . . . READ Pointer Table RAM (Hash)
S406 . . . READ Main Table RAM
S408 . . . CORRESPONDING DATA?
S410 . . . DELETE DATA
S412 . . . READ Pointer Table RAM (Ext) IN ADDRESS ORDER

End of Retrieval Key Deleting Process

### FIG. 7

Retrieval Range Deleting Process
S500 . . . DELETE POSITION INFORMATION OF WILDCARD PORTION FROM MASK Table
S501 . . . CONVERT WILDCARD PORTION OF RETRIEVAL RANGE DEFINING DATA TO FIXED VALUE
S502 . . . CONVERT RETRIEVAL RANGE DEFINING DATA USING HASH FUNCTION
S504 . . . READ Pointer Table RAM (Hash)
S506 . . . READ Main Table RAM
S508 . . . CORRESPONDING DATA?
S510 . . . DELETE DATA
S512 . . . READ Pointer Table RAM (Ext) IN ADDRESS ORDER

End of Retrieval Range Deleting Process

### FIG. 8

Mask Value Number of Data

### FIG. 9

Retrieval Range Registering Process
S200A . . . REGISTER POSITION INFORMATION OF WILDCARD PORTION IN MASK Table
S201A . . . CONVERT WILDCARD PORTION OF RETRIEVAL RANGE DEFINING DATA TO FIXED VALUE
S202 . . . CONVERT RETRIEVAL RANGE DEFINING DATA USING HASH FUNCTION
S204 . . . READ Pointer Table RAM (Hash)
S206 . . . IS DATA EMPTY?
S208 . . . STORE INFORMATION IN Pointer Table RAM (Hash) WITH ADDRESS ASSOCIATED THEREWITH
S210 . . . STORE INFORMATION IN Pointer Table RAM (Ext) WITH ADDRESS ASSOCIATED THEREWITH
S212 . . . STORE INFORMATION AT ASSOCIATED ADDRESS OF Main Table RAM

End of Retrieval Range Registering Process

### FIG. 10

Mask bit Position Value Number of Data

### FIG. 11

Retrieving Process
S300A . . . OUTPUT RETRIEVAL KEY DATA AS IT IS AND OUTPUT CONVERTED RETRIEVAL KEY DATA OBTAINED BY COVERTING DATA OF NUMBER OF BITS INDICATED BY POSITION INFORMATION AS COUNTED FROM LEAST SIGNIFICANT BIT TO FIXED VALUE
S302 . . . CONVERT RETRIEVAL KEY DATA AND CONVERTED RETRIEVAL KEY DATA USING HASH FUNCTION
S304 . . . READ Pointer Table RAM (Hash)
S306 . . . READ Main Table RAM
S308 . . . CORRESPONDING DATA?
S310 . . . READ Pointer Table RAM (Ext) IN ADDRESS ORDER

End of Retrieving Process

### FIG. 12

Retrieval Range Deleting Process
S500A . . . DELETE POSITION INFORMATION OF WILDCARD PORTION FROM MASK Table
S501 . . . CONVERT WILDCARD PORTION OF RETRIEVAL RANGE DEFINING DATA TO FIXED VALUE
S502 . . . CONVERT RETRIEVAL RANGE DEFINING DATA USING HASH FUNCTION
S504 . . . READ Pointer Table RAM (Hash)
S506 . . . READ Main Table RAM
S508 . . . CORRESPONDING DATA?
S510 . . . DELETE DATA
S512 . . . READ Pointer Table RAM (Ext) IN ADDRESS ORDER

End of Retrieval Range Deleting Process

### FIG. 13

Mask Bit Position Value Number of Data

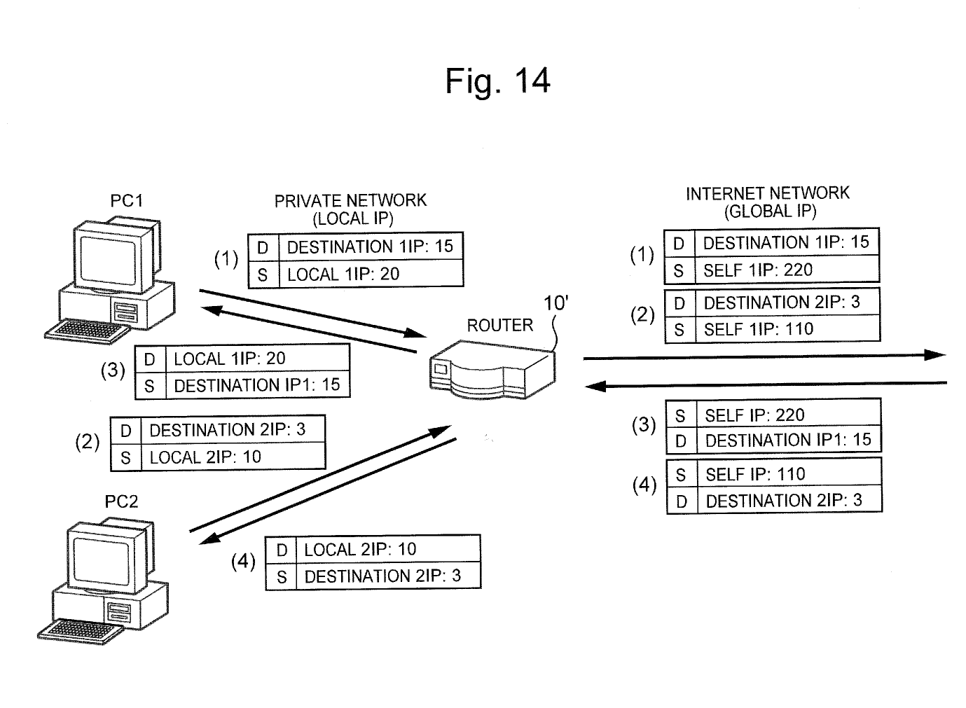

### FIG. 14

Private Network (Local IP)
(1) DESTINATION

LOCAL
(2) DESTINATION

LOCAL
(3) LOCAL

DESTINATION
(4) LOCAL

DESTINATION

Internet Network (Global IP)
(1) DESTINATION

SELF
(2) DESTINATION

SELF
(3) SELF

DESTINATION
(4) SELF

DESTINATION

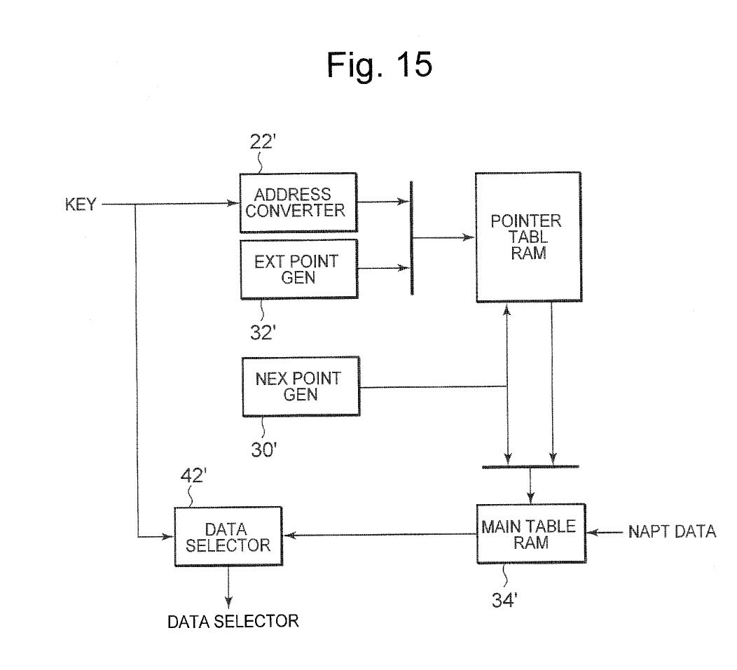

### FIG. 15

22′ . . . ADDRESS CONVERTER, 42′ . . . DATA SELECTOR

What is claimed is:

1. An information retrieving apparatus comprising:
first storing means for storing predetermined information at addresses, said addresses being associated with retrieval key data by substituting data indicative of each specific position of the retrieval key data in retrieval range defining data in which a range targeted for retrieval is defined by setting the retrieval range defining data as information indicative of the data being arbitrary data, with a fixed value defined in advance, and performing conversion on the retrieval key data by predetermined hash functions;
second storing means for storing position information indicative of the specific position therein;
means for, when retrieval key data targeted for retrieval is inputted, reading the position information from the second storing means and reading from the first storing means, the information stored at the addresses associated therewith by substituting the data indicative of each specific position indicated by the position information of the retrieval key data with the fixed value and converting the retrieval key data by the hash functions; and
means for determining whether each information read by the reading means is of the predetermined information.

2. The information retrieving apparatus according to claim 1, wherein the first storing means stores information associated with the retrieval key data at addresses associated with said data by converting the retrieval key data using the hash functions, and wherein when retrieval key data targeted for retrieval is inputted, the reading means further reads from the first storing means, the information stored at the addresses associated with said data by converting the retrieval key data using the hash functions.

3. The information retrieving apparatus according to claim 1, wherein when a plurality of retrieval range data identical in the specific position are registered, only one position information is stored as said position information.

4. The information retrieving apparatus according to claims 1, wherein the position information is of information indicating the specific position by a bit position.

5. The information retrieving apparatus according to claim 1, wherein the position information is of information indicating the specific position by the number of bits as counted from the least significant bit.

6. An information retrieving method comprising the steps of: storing predetermined information at addresses of first storing means, said addresses being associated with retrieval key data by substituting data indicative of each specific position of the retrieval key data in retrieval range defining data in which a range targeted for retrieval is defined by setting the retrieval range defining data as information indicative of the data being arbitrary data, with a fixed value defined in advance and performing conversion on the retrieval key data by predetermined hash functions, and storing position information indicative of the specific position in second storing means;
when retrieval key data targeted for retrieval is inputted, reading the position information from the second storing means and reading from the first storing means, the information stored at the addresses associated therewith by substituting the data indicative of each specific position indicated by the position information of the retrieval key data with the fixed value and converting the retrieval key data by the hash functions; and
determining whether each read information is of the predetermined information.
